(19) United States
(12) Patent Application Publication
(10) Pub. No.: US 2015/0206526 A1
(43) Pub. Date: Jul. 23, 2015

(54) Method for outputting information by means of synthetic speech

(71) Applicant: CONTINENTAL AUTOMOTIVE GMBH, Hannover (DE)

(72) Inventor: Bernhard Schild, Wetzlar (DE)

(21) Appl. No.: 14/418,709

(22) PCT Filed: Jun. 27, 2013
(86) PCT No.: PCT/EP2013/063521

§ 371 Date: Jan. 30, 2015

(30) Foreign Application Priority Data
Aug. 1, 2012 (DE) 10 2012 213 609.6

(51) Int. Cl. G10L 13/02

(52) U.S. Cl. CPC G10L 13/02

(57) ABSTRACT

A method for outputting information by synthetic speech during voice communication over a multidirectional connection between a communication device of a first subscriber and a communication device of at least one second subscriber, wherein by using a vehicle information system with integrated speech synthesis system present in a motor vehicle, at least one item of information delivered by the vehicle information system and selected by the first user via an input unit is converted into a speech synthesis signal by the speech synthesis system. The speech synthesis signal is mixed with a voice signal that can be input via a microphone, and is delivered as a speech output signal to the communication device, or the speech synthesis signal is delivered as a speech output signal to the communication device and the speech output signal is sent via the multi-directional connection to the communication device of at least the second user.

### CROSS-REFERENCE TO RELATED APPLICATIONS

This is a U.S. national stage of application No. PCT/EP2013/063521, filed on 27 Jun. 2013, which claims priority to the German Application No. DE 10 2012 213 609.6 filed 1 Aug. 2012, the content of both incorporated herein by reference.

### BACKGROUND OF THE INVENTION

1. Field of the Invention

The invention relates to a method for outputting information by means of synthetic speech in voice communication, which is provided via a multidirectional connection between a communication appliance of a subscriber A and at least one further communication appliance of a subscriber B.

2. Related Art

A road user abroad is not always able to express himself correctly in the respective national language, which can result in misunderstandings particularly in the case of a telephone call during emergency or breakdown situations. This makes communication more difficult and may hamper the initiation of vital rescue measures. Such misunderstandings can also be encountered by a road user abroad during ordinary telephone calls with service desks through the incorrect pronunciation of locations, addresses, POIs (points of interest) or names of persons, however. Although modern navigation systems or information systems integrated in motor vehicles have voice output devices or speech synthesis systems for reproducing visually presented information, the poor acoustics thereof or possible ambient noise hampers satisfactory transmission to a subscriber during a conducted telephone call.

A publication in the trade journal (www.handelsblatt.com/auto/test-techik/ford-sync-automatischer-notruf-ohne-mobilfunk-abo dated Mar. 21, 2011) already discloses an onboard computer voice controller “sync” that has an automatic emergency call assistant. In an emergency situation, the emergency call assistant is used to set up a telephone connection via a mobile telephone to an emergency call service, with the system automatically communicating with the emergency call service in the respective national language and in so doing transmitting the current position of the motor vehicle in the respective national language. An automatic emergency call of this kind can be terminated by a driver or passenger only manually. Direct influencing of the content of such an emergency call is not possible, however.

The document US 2009/0265022 A1 describes a communication appliance and a basic method for reproducing multimedia contents during a multimedia transmission. In this case, the multimedia contents stored on the communication appliance are inserted into a multimedia transmission when a key is operated. In addition, the method is meant to allow the voice output of texts stored on the communication appliance to a multimedia transmission by a speech synthesis system (TTS: text to speech).

### SUMMARY OF THE INVENTION

In view of the problems presented above, it is an object of the present invention to provide a method for voice output of information from a navigation or vehicle information system in voice communication, e.g., in a telephone call, using different languages too.

This object is achieved, in accordance with an aspect of the invention, by a method for outputting information by synthetic speech during voice communication, which is provided via a multidirectional connection between a communication appliance of a first subscriber and a communication appliance of at least one second subscriber, using a vehicle information system with an integrated speech synthesis system that is in place in a motor vehicle. The method involves at least one piece of information that is delivered by the vehicle information system, and that is selected by the first subscriber using an input unit, being converted into a speech synthesis signal by the speech synthesis system, and the speech synthesis signal being mixed with a call signal that can be input via a microphone, and being delivered to the communication appliance as a voice output signal, or the speech synthesis signal being delivered to the communication appliance as a voice output signal, and the voice output signal being sent via the multidirectional connection to the communication appliance of at least the second subscriber.

The call signal that can be input via the microphone can be converted into a data stream, wherein the speech synthesis signal is integrated into the data stream or replaces a portion of the data stream. To this end, it is possible to use an analog-to-digital converter, for example, which converts the analog audible voice signal from the subscriber into a digital data signal, the data of which are compiled to form a data stream in accordance with prescribed formats. The data stream can be mixed with the speech synthesis signal in a mixing device that is integrated in the vehicle information system and that may be in the form of an audio microcontroller. In this case, the data of the call signal can be replaced by data from the speech synthesis signal, or the data of the speech synthesis signal can be added to the data stream, which produces a modified data stream that is called a voice output signal, which is delivered to the communication appliance. Naturally, the voice output signal can contain essentially only the speech synthesis signal, which consists of a plurality of speech synthesis elements.

The voice communication conducted via a multidirectional connection to the communication appliance of a first subscriber and a communication appliance of a further subscriber may be a conventional telephone call in which a bidirectional connection materializes by virtue of the first subscriber calling at least one further subscriber, who agrees to the voice communication by accepting the call.

The multidirectional connection allows the setup of a simultaneously multidirectional connection from the communication appliance of the first subscriber to a plurality of communication appliances of further subscribers. This allows the first subscriber to simultaneously contact a large number of further subscribers for voice communication.

In principle, a telephone call is intended to be understood to mean communication links that involve the interchange of at least audio signals (voice output signals) that allow the transmission of voice. By way of example, this includes communication via VoIP (Voice over IP, Internet protocol telephony) as well. Such communication links may exist temporarily or permanently, for example by a GSM (Global System for Mobile Communications), UMTS (Universal Mobile Telecommunications System), LTE (Long Term Evolution) or WLAN (Wireless Local Area Network).

The multidirectional connection for voice communication can be provided via VoIP. In this case, the information that is typical for telephony, such as voice and control information, for example for connection setup, can be transmitted via computer networks and via the Internet. To this end, it is possible to use specific VoIP software such as Skype or Facetime, which are installed on a communication appliance or electronic terminal, for example tablet PC, with Internet access. The multidirectional connection for voice communication can alternatively be set up using telephone terminals that are specialized for VoIP or else conventional telephones connected via specific adapters.

The method according to the invention allows the use of a vehicle information system with a speech synthesis system that is already in place in a motor vehicle for the purpose of integrating the voice output of various information delivered by the vehicle information system into a telephone call, conducted between at least two subscribers, in real time in a desired language. A driver or passenger of the motor vehicle who is a subscriber in a telephone call with at least one further subscriber can select a piece of information delivered by the vehicle information system by operating an input unit of the vehicle information system and can insert the information into the telephone call as a voice output with synthetic speech at a desired instant. The direct integration of the voice output in the telephone call allows the piece of information chosen by a driver or passenger to be reproduced without audible quality losses as part of the telephone call with correct audible pronunciation, as a result of which misunderstandings can be avoided.

The vehicle information system can be understood to be a central data processing unit in which all data paths from peripheral devices of a motor vehicle, such as from engine electronics, safety electronics or a position unit (GPS receiver), converge, so that the data from the peripheral devices can be managed and output to a driver or passenger as information. Accordingly, a vehicle information system should contain all parts of a computer system that operates on the basis of the input/processing/output principle. Particularly the position unit should be used to determine position data, with such position data being able to be processed in a microcontroller that is integrated in the vehicle information system and being able to be stored in a memory.

In addition, the vehicle information system may have an integrated navigation apparatus. Alternatively, the vehicle information system may be in the form of a navigation apparatus, with the cited data paths of the peripheral devices converging in the navigation apparatus. In this case, the data from the peripheral devices are accordingly processed and output by the navigation apparatus. The navigation apparatus should comprise at least the position unit, the microcontroller, the speech synthesis system, a memory and an indicator unit for visual or audible output of information.

The vehicle information system and/or the navigation apparatus may be a radio navigation appliance, which is also called an automotive head unit. In this case, a piece of VoIP software may be installed on the automotive head unit. In addition, such an automotive head unit may also have further data paths to multimedia services or databases, such as address books or diaries. The further data paths can be set up to further mobile terminals via communication links, via cable or radio.

The data processed by the vehicle information system or by the navigation apparatus should be visually displayed to the driver or passenger using a central indicator unit, such as an LCD/LED/OLED screen, head-up display or by projection onto a surface (e.g., windshield).

A large number of pieces of information used in a navigation device or the vehicle information system for a motor vehicle can be stored in the speech synthesis system or in a memory as speech synthesis elements. In order to form speech synthesis signals with information in a particular language, speech synthesis elements can be selected on the basis of a current position or a position chosen as a destination in the navigation apparatus. The relevant data for the current position can be retrieved from the position unit, which is part of the navigation apparatus or is integrated in the motor vehicle separately as a peripheral device.

The at least one piece of information delivered via the vehicle information system may be a position statement, a direction statement, a route, a name of a person, a date, an attraction and/or a distance. By way of example, this may be a POI (point of interest), such as gastronomy, accommodation, filling stations, automated teller machines or parking garages. Alternatively, POIs may be drop-in centers in urgent situations, such as autorepair shops, pharmacies or hospitals, or they indicate tourist attractions and leisure facilities, including cinemas, sports stadia, museums and other attractions.

Alternatively, it is possible for information from databases such as address books or diaries to be output, the information being transferred to the vehicle information system by the communication appliance of a driver or passenger, for example, and being presented on the indicator unit.

In addition, the at least one piece of information delivered by the vehicle information system may be a piece of visually presentable or audibly indicatable information from engine electronics, safety electronics, a vehicle diagnosis memory and/or a vehicle error memory. Hence, the subscriber, driver or passenger can also integrate into a telephone call such information as relate to the state of the motor vehicle. In particular, this allows diagnosis information to be inserted audibly into a telephone call with a motor vehicle workshop, for example. By way of example, it is thus also possible for information from error and/or diagnosis memories to be selected without user input the moment that (one of) the communication partner(s) or second subscriber(s) is known to be a motor vehicle workshop, breakdown service or the like according to POI (Point of Interest) information or an entry in an electronic address book or diary. This information can then optionally also be transmitted to this communication partner automatically, without further action from the user or first subscriber, for example as a voice message on a telephone answering machine, when the communication from a remote station of this kind is set up.

The subscriber, driver or passenger can determine the instant for output of the speech synthesis signal to the telephone call as desired. For checking purposes, the voice output signal delivered to the communication appliance can be reproduced as voice via a loudspeaker that is integrated in the communication appliance and/or in the vehicle information system. Hence, the subscriber can ensure that the speech synthesis signal has been inserted into the voice output signal at the correct position.

The vehicle information system and the communication appliance can be in contact for signal interchange via radio. In this case, it is possible for an already existing connection, for example via Bluetooth or WLAN, that has been set up between the communication appliance and the vehicle information system in order to provide a hands-free connection, to be used for transmitting the voice output signal. Such a connection can be used to provide what are known as virtual channels, which may be embodied as virtual audio channels or control channels, having a transmission protocol such as Bluetooth Handsfree Protocol, with control or command messages being able to be transmitted from the vehicle information system to the communication appliance, for example. Virtual channels or virtual connections arise by virtue of an association between two communication subscribers, the association requiring only temporary resources for message transmission in the case of active communication. In this case, the virtual channel exists only in what are known as connection tables for the communication partners involved. Alternatively, the connection tables can contain persistent associations, so that a virtual channel can also outlast the switching-off of the communication appliances involved.

Alternatively, the voice output signal can be transmitted between the vehicle information system and the communication appliance by an optical connection or a cable connection. Accordingly, the vehicle information appliance should have at least one communication interface. The use of such a communication interface that is already in place in a vehicle information system allows setup of a connection to different communication appliances of various drivers or passengers. This is found to be advantageous when a corresponding motor vehicle is used as a rental vehicle by a plurality of drivers, for example.

The input unit may be in the form of an indicator unit with a touch-sensitive surface (touch display). In this case, a piece of information presented by the vehicle information system using the indicator unit can be selected when touched. Upon selection of a piece of information, for example an address with a name, the subscriber can decide whether only the name or else the name and the address is/are meant to be output as a speech synthesis signal. To this end, a list of selection options opens on the indicator unit. In this case, the subscriber can also decide whether the speech synthesis signal is additionally reproduced via a loudspeaker integrated in the motor vehicle during the telephone call that is conducted.

In addition, the input unit used may also be a pushbutton switch, rotatable selection wheel or optical sensor. Optical sensors can be used to control the selection of a piece of information delivered by the vehicle information system by gestures. In this case, a piece of information projected on a surface, for example on the windshield, can be selected by a simple finger movement. This is found to be advantageous particularly in the case of drivers who are unaware of the arrangement of various input devices in the relevant motor vehicle. Furthermore, the vehicle information system may have voice control that can be used to select a piece of information delivered by the vehicle information system. A further variant of the method may involve the generation of telephone announcements, which essentially consist of synthetic speech. In this case, call elements, which are likewise stored as speech synthesis elements, can be selected by the driver or passenger and if need be combined with the speech synthesis elements of the information that is likewise selected to form a speech synthesis signal. In this way, it is possible for a telephone call to begin with the correspondingly generated telephone announcement.

During a telephone call, the voice output signal can be buffer-stored with the admixed speech synthesis signal, e.g., in the memory and/or in an output memory. In this way, the first subscriber can send the voice output signal or part thereof to the at least one further subscriber repeatedly. This is found to be advantageous when the connection is disturbed, for example. The first subscriber can listen to the buffer-stored voice output signal via the loudspeaker during the telephone call too before the signal is sent to the at least one further subscriber. In addition, the first subscriber can store the buffer-stored voice output signal in the memory permanently. Optionally, the buffer-stored voice output signal can be stored and logged on an external storage medium, so that the subscriber can use the voice output signal outside the motor vehicle too. In this way, the relevant information from the vehicle information system can also be reproduced during voice communication with synthetic speech at a later instant.

The mixing device can also be used to mix speech synthesis signals generated by the speech synthesis system into call signals that have been received by the communication appliance of the first subscriber during a telephone call with the at least one second subscriber. This received signal mixed with the speech synthesis signal can be rendered audible via a loudspeaker. This allows the first subscriber to send queries to the second subscriber, for example, following output of the voice output signal when the second subscriber has spoken further during the transmission of the voice output signal.

As already explained, position data that are ascertained by the position unit can be taken as a basis for generating telephone announcements that output the current position in the correctly pronounced national language to a caller at the beginning of a telephone call, for example as part of a greeting. Particularly information such as locations or names of persons that contains Asian characters, for example, can thus be reproduced in the correct pronunciation.

A device according to the invention for carrying out a method as cited above for outputting information by synthetic speech during voice communication, which is provided via a multidirectional connection between a communication appliance of a first subscriber and a communication appliance of at least one second subscriber, can comprise a communication appliance, having a microphone, and a vehicle information system, between which it is possible to set up a communication link via a communication interface integrated in the vehicle information system for the purpose of interchanging signals. The vehicle information system comprises an input unit that can be used to select a piece of information delivered by the vehicle information system, a speech synthesis system having a memory for storing speech synthesis elements that is able to be used to convert the information into a speech synthesis signal, and a mixing device that can be used to mix the speech synthesis signal with a call signal that can be input via a microphone and to deliver it to the communication appliance as a voice output signal or to deliver the speech synthesis signal to the communication appliance as a voice output signal. In addition, the vehicle information system comprises an indicator unit for indicating information that is delivered at least by the navigation apparatus. In this case, the vehicle information system may comprise a navigation apparatus, or may be in the form of a radio navigation appliance (what is known as a head unit). The communication appliance may be an appliance (e.g., a mobile telephone) that is separate from the vehicle information system, but may also be integrated in the vehicle information system.

The method according to the invention is explained in more detail below with reference to an exemplary embodiment.

### BRIEF DESCRIPTION OF THE DRAWING

In the drawing:

FIG. 1 shows a block diagram of an exemplary embodiment of a device for outputting information by synthetic speech during voice communication.

### DETAILED DESCRIPTION OF THE PRESENTLY PREFERRED EMBODIMENTS

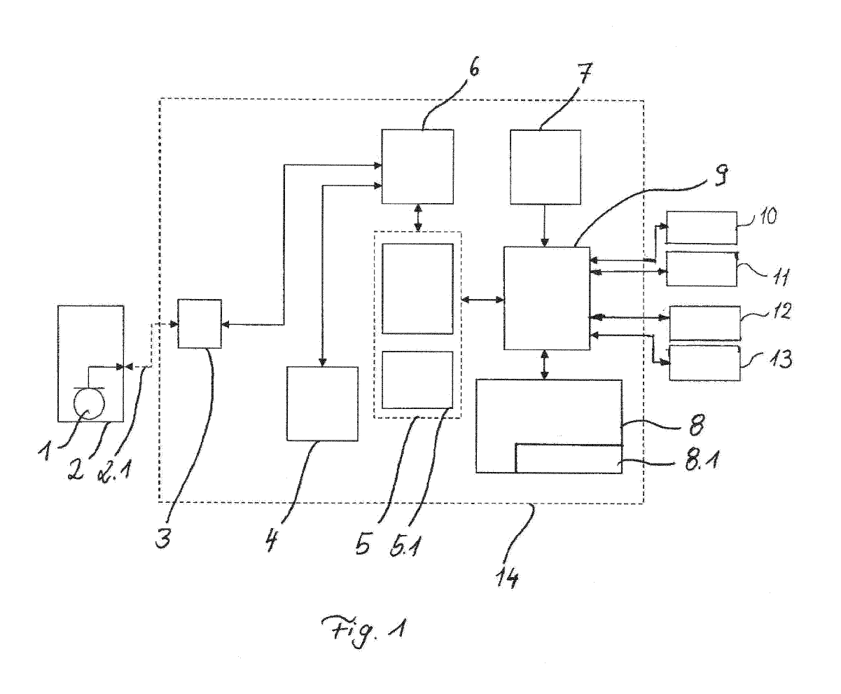

FIG. 1 shows a device for outputting information by synthetic speech during voice communication. The device comprises a communication appliance 2 in the form of a mobile telephone and a vehicle information system 14 (in a dashed border) that is at least in the form of a navigation appliance, a radio navigation appliance or an automotive head unit but may contain additional functions, as explained further on. Between the communication appliance 2 and the vehicle information system 14, it is possible to set up a communication link 2.1 via a communication interface 3. In another embodiment, the communication appliance 2 may also be integrated in the vehicle information system 14.

In addition, the vehicle information system 14 comprises a microcontroller 9 as a central data processing unit in which the data paths from a position unit 7, engine electronics 10, an indicator unit 8 with an input unit 8.1, safety electronics and a speech synthesis system 5 (TTS; Text to Speech) converge. In addition, there are data paths to vehicle diagnosis memories 12 and vehicle error memories 13, which are external as seen from the vehicle information system 14 and which are updated generally by controllers in the motor vehicle as required and can be read by the microcontroller 9.

A memory 5.1, which in this case is shown as part of the speech synthesis system 5, but may also be seen separately therefrom, stores the data and information necessary for navigation, and also speech synthesis elements, from which the speech synthesis system 5 generates speech synthesis signals that represent the synthetic speech. The data and information delivered by the apparatuses 10 and 11 can also be stored and retrieved.

The input unit 8.1 is integrated in the indicator unit 8 and in the form of a touch-sensitive surface (touch screen) on the indicator unit 8.

In addition, the vehicle information device 14 has a mixing device 6 that is connected to the speech synthesis system 5, or is part thereof. The mixing device 6, which may be in the form of an audio microcontroller, can be used to mix the speech synthesis signals generated and delivered by the speech synthesis system 5 with call signals, which the communication appliance 2 usually delivers in the form of a data stream, as explained below.

The call signals from a subscriber can be formed using a microphone 1 provided in the communication appliance 2 or a microphone integrated in the vehicle information system 14 (not shown) or can be forwarded via the communication interface 3 by a reception channel of the communication appliance 2. The output of the mixing device 6 delivers voice output signals that are routed, via the communication interface 3, to the communication appliance 2 for sending via a transmission channel. The voice output signals can also be output by a loudspeaker 4 that has a connection to the mixing device 6.

The vehicle information system 14 that is in place in the motor vehicle and that, is at least in the form of a navigation apparatus, is used to present the current position of the motor vehicle on the indicator unit 8 on the basis of position data from the position unit 7.

The memory 5.1 stores speech synthesis elements that relate to the information used in connection with a navigation appliance, the speech synthesis elements being provided for different languages. In principle, the language can be preset by the driver, but it can also be changed selectively while driving, possibly on the basis of information from a navigation appliance. Different interactions during the communication are possible between the vehicle information system 14 (e.g., radio navigation appliance or automotive head unit) and the communication appliance 2, e.g., mobile telephones with or without an adapter. By way of example, permanent or selective setup of a virtual audio channel in the transmission direction, which is used to transmit the voice output signal to the communication appliance 2, for example, and of a virtual audio channel in the reception direction, which is used to transmit the call signal received by the communication appliance 2 to the automotive head unit, for example, is possible. In addition, a virtual channel for control messages from the mobile telephone to the automotive head unit or a virtual channel for command messages from the automotive head unit can be or may have been set up. By way of example, the communication can be performed using BTHPF (Bluetooth Handsfree Protocol).

The virtual channels can be set up via the communication link 2.1 to the mobile telephone of the driver or passenger when the automotive head unit is actually switched on. Thus, the mobile telephone can send, by way of example, a control message to the automotive head unit via a virtual control channel, which is used to visually display a telephone call incoming via the mobile telephone (via GSM network or VoIP) by the indicator unit 8 of the automotive head unit.

In a further example, the mobile telephone can send a control message via a further virtual channel, the control message being used to accomplish the handover of a telephone call conducted using the mobile telephone (via GSM network or VoIP) to the automotive head unit, so that the telephone call is henceforth conducted via the automotive head unit. During the handover, the connection that has been set up for the telephone call is maintained, control of this connection being undertaken by the automotive head unit. Nevertheless, the automotive head unit can send an appropriate command message to the mobile telephone, which command message is used to prompt handover of the existing telephone call from the automotive head unit to the mobile telephone, with the connection being maintained in this case too.

In the event of connection termination by the GSM network, for example as a result of loss of network reception in the event of a disturbance, a control message can likewise be sent to the automotive head unit that prompts presentation of this information on the indicator unit 8 and/or an audible output via the loudspeaker 4.

In addition, command messages from the automotive head unit to the mobile telephone can be used to initiate setup of a telephone connection for a telephone call via the GSM network, for example. In this case, the relevant command messages can be input by the driver or passenger using the input unit 8.1. Similarly, such a telephone call can be terminated by a command message that is input via the input unit 8.1 and that is sent to the mobile telephone for the purpose of connection cleardown.

The mobile telephone sends the transmission signals to the network, for example via GSM, UMTS, LTE, WLAN and the like.

The different options for handling voice signals in the vehicle information system 14 are described below.

The call signals that are input via the microphone 1 or a microphone integrated in the vehicle information system 14 (not shown) are mixed with the speech synthesis signal from the speech synthesis system 5 in the mixing device 6, that is to say that the data of the speech synthesis signal are inserted into the data of the call signal or replace some of the data of the call signal. The resultant voice output signals are transmitted to the mobile telephone or the communication appliance 2 and to the transmission channel of the telecommunication link.

Another option involves the mixing device 6 comprising an “audio channel” changeover switch that can change over between the call signals delivered by the microphone 1 or by the internal microphone that is not shown and the speech synthesis signal. This means that the voice output signal may be a juxtaposition of both of these signals.

Among the options, for the purpose of transmission to the transmission channel it is additionally possible to send the voice output signal to the loudspeaker 4.

Correspondingly, a call signal received by the communication appliance 2 can be mixed with the speech synthesis signal in the mixing device 6 or changed over between the two, the voice output signal formed being able to be rendered audible via the internal loudspeaker 4.

When a driver is out and about with his motor vehicle, his route chosen by the navigation appliance is usually indicated with a start, a current position and a destination, possibly with intermediate destinations, on the indicator unit 8, e.g., in a map of the surroundings of the motor vehicle.

If the driver intends to use his communication appliance 2 to conduct voice communication with another subscriber, during which information from the navigation appliance or additional information from the vehicle information system 14 is intended to be used as a synthetic speech signal, for example in the language of the surroundings that the motor vehicle is in, he will take known precautions for setting up or activating a connection to at least one further subscriber. The information that is intended to be passed on can be selected, by way of example, by touching positions on the map on the indicator unit 8 in the form of a touch screen.

Thus, the speech synthesis system 5 can be used to produce speech synthesis signals for any positions selected by touch on the map, as an address, possibly as a POI and an address, for example for a restaurant or a hotel. The current vehicle position, a starting point or a destination for a route or a desired intermediate position on a route can also be output as an address, possibly as a POI and an address, when a POI is nearby, by synthetic speech.

Furthermore, speech synthesis signals can also be produced for information from electronic address books or diaries that is transmitted from the communication appliance 2 of a driver to the vehicle information system 14 and presented on the indicator unit 8, for example. The driver is thus able to select a name and an address, for example, or just the name or just the address, e.g., of a doctor or of a company branch, for voice output from a, by way of example, electronic public address book that is presented by the indicator unit 8 in list or table form. This likewise applies to the names and/or addresses, for example from a private electronic address book of the driver, for example of a friend, family member or a business partner.

The data delivered by the engine electronics 10 and the safety electronics 11 can also be presented by the indicator unit 8 and selected for voice output. These data may relate to information pertaining to engine temperature, oil level or tire pressure, for example.

The language required for the synthetic speech, that is to say for the speech synthesis signals, can be selected by the driver actively, for example on a list presented on the indicator unit 8, or the language of the area at the selected position of interest, for example the language at the start, the destination or corresponding intermediate positions, is determined automatically. The microcontroller 9 actuates the speech synthesis system 5 and the memory 5.1 on the basis of the input by the driver, with the corresponding speech synthesis elements that contain the information being actuated in order to form the desired speech synthesis signal in the selected language. The speech synthesis signal is processed further as described above.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-12. (canceled)

13. A method for outputting information by synthetic speech during voice communication via a multidirectional connection between a communication appliance (2) of a first subscriber and a communication appliance of at least one second subscriber, using a vehicle information system (14) having an integrated speech synthesis system (5) in a motor vehicle, the method comprising:
converting, by the speech synthesis system (5), at least one piece of information delivered by the vehicle information system (14) and selected by the first subscriber using an input unit (8.1), into a speech synthesis signal, and
mixing the speech synthesis signal with a call signal input via a microphone (1), and delivering the mixed speech synthesis signal and call signal to the communication appliance (2) as a voice output signal, or delivering the speech synthesis signal to the communication appliance (2) as a voice output signal, and
sending the voice output signal via the multidirectional connection to the communication appliance of the at least one second subscriber.

14. The method as claimed in claim 13, further comprising converting the call signal input via the microphone (1) into a data stream, wherein the speech synthesis signal is integrated into the data stream or replaces a portion of the data stream or is inserted before or after the data stream of the call signal.

15. The method as claimed in claim 13,
wherein the vehicle information system (14) has an integrated navigation apparatus or the vehicle information system (14) is in the form of a navigation apparatus.

16. The method as claimed in claim 13,
wherein the voice communication is via VoIP or via a bidirectional telephone connection.

17. The method as claimed in claim 13,
wherein a number of pieces of information used in a navigation device of a motor vehicle are stored in the speech synthesis system (5) as speech synthesis elements, and, to form speech synthesis signals with information in a particular language, speech synthesis elements are selected on the basis of a current position, a desired intermediate position or a position chosen as destination in the navigation apparatus.

18. The method as claimed in claim 13,
wherein the at least one piece of information delivered by the vehicle information system (14) is a position statement, a direction statement, a route, a name of a person, an address, a date, an attraction and/or a distance.

19. The method as claimed in claim 13,
wherein the at least one piece of information delivered by the vehicle information system (14) is a visually presentable or audibly indicatable piece of information from engine electronics (10), safety electronics (11), an error memory (13) and/or a diagnosis memory (12).

20. The method as claimed in claim 13,
wherein the voice output signal delivered to the communication appliance (2) is reproduced as speech via a loudspeaker (4) integrated in the communication appliance (2) and/or in the vehicle information system (14).

21. The method as claimed in claim 13,
wherein the vehicle information system (14) and the communication appliance (2) are connected via radio for signal interchange.

22. The method as claimed in claim 13,
wherein the selection of the information delivered by the vehicle information system (14) is controlled by voice, handwriting input or gestures.

23. The method as claimed claim 13, wherein the speech synthesis signal is mixed with a received call signal received by the communication appliance (2) and is output audibly via the loudspeaker (4).

24. A device for carrying out a method as claimed in claim 13, the device having a communication appliance (2), a microphone (1), and a vehicle information system (14) having a navigation apparatus, between which it is possible to set up a communication link for the purpose of interchanging signals, the vehicle information system (14) further comprising:
an input unit (8.1) configured to control functions of the vehicle information system (14) and to select indicated information,
a speech synthesis system (5) having a memory (5.1) for storing at least speech synthesis elements relating to the information, wherein the speech synthesis system (5) is configured to convert the information into a speech synthesis signal,
a mixing device (6) configured to mix the speech synthesis signal with a call signal input via a microphone (1) and to deliver the mixed speech synthesis signal and call signal to the communication appliance (2) as a voice output signal or to deliver the speech synthesis signal to the communication appliance (2) as a voice output signal, and
an indicator unit (8) configured to indicate information that is delivered at least by the navigation apparatus.
